(19) United States
(12) Patent Application Publication
(10) Pub. No.: US 2026/0302664 A1
(43) Pub. Date: Oct. 1, 2026

(54) ELECTRICAL CONNECTOR FOR CIRCUIT BOARDS

(71) Applicant: Hirose Electric Co., Ltd., Yokohama (JP)

(72) Inventors: Ray KISER, Yokohama (JP); Hiromichi MURAOKA, Yokohama (JP); Nobuhiro TAMAI, Yokohama (JP); Shigeru KAWASAKI, Yokohama (JP)

(21) Appl. No.: 19/576,792

(22) Filed: Mar. 24, 2026

(30) Foreign Application Priority Data
Mar. 28, 2025 (JP) 2025-056262

(51) Int. Cl. H01R 12/71; H01R 4/02

(52) U.S. Cl. CPC H01R 12/716; H01R 4/027

(57) ABSTRACT

In an electrical connector for circuit boards 1 mounted on the mounting face of a circuit board, there are provided a plurality of socket terminals 20 having a connection portion 22 used for connecting to the mounting face formed at one end, a socket housing that retains the plurality of socket terminals 20, and solder connection members 30 attached to the connection portions 22, and the solder connection members 30 have ridge lines extending along the mounting face on the side facing the mounting face.

### CROSS-REFERENCE TO RELATED APPLICATIONS

This application claims priority to Japanese Patent Application No. 2025-056262, filed Mar. 28, 2025, the contents of which are incorporated herein by reference in its entirety for all purposes.

### BACKGROUND

### Technical Field

The present invention relates to an electrical connector for circuit boards mounted on the mounting face of a circuit board.

### Background Art

The connector of Patent Document 1 is known as an example of such an electrical connector for circuit boards. In the connector of Patent Document 1, a plurality of terminals are retained in a housing, with a solder ball (soldering structure) adhered to each terminal. Specifically, the terminals, which have a board connection portion that is exposed at the bottom face of the housing and that extends along the mounting face of a circuit board, have a solder ball adhered to the bottom face of said board connection portion. When viewed from below, the solder ball is of an elliptical shape and of a downwardly protruding dome shape. In other words, the solder ball has a downwardly protruding curved bottom edge when viewed in any direction parallel to the mounting face, and the protruding apical point thereof is the bottom end.

### Patent Documents

### Patent Document 1

Japanese Patent Application Publication No. 2013-080591

### SUMMARY

### Problems to be Solved

In connectors in which solder balls are adhered to the terminals as described in Patent Document 1, an inspection to measure the degree of solder ball flatness is often performed before mounting on a circuit board. During such an inspection, the connectors are imaged from below and the position of the bottom ends of the solder balls in a direction perpendicular to the mounting face is detected based on the captured images. The degree of flatness is then determined based on the extent of variation in the position of the bottom end among all the solder balls. Highly accurate measurements of the degree of flatness are required during the above-mentioned inspection because the degree of solder ball flatness is an important indicator that affects the stability of solder connections to a circuit board.

In the connector of Patent Document 1, the bottom ends of the solder balls are dome-shaped. Consequently, accurate detection of the position of the bottom ends of the solder balls is not easy because the bottom ends of the solder balls are detected as points in the connector images captured from below during the above-mentioned inspection. If the position of the bottom ends of the solder balls cannot be accurately detected, it is extremely difficult to determine the degree of solder ball flatness with high accuracy.

In light of these circumstances, it is an object of the present invention to provide an electrical connector for circuit boards in which the degree of flatness of the solder connection members can be determined with high accuracy.

### Technical Solution

(1) An electrical connector for circuit boards according to an aspect of the present invention is mounted on the mounting face of a circuit board.

Such an electrical connector for circuit boards comprises a plurality of terminals having a connection portion used for connecting to the mounting face formed at one end, a housing that retains the plurality of terminals, and solder connection members attached to the connection portions, and is characterized in that the solder connection members have at least one ridge line extending along the mounting face on the side facing the mounting face.

The solder connection members used in the above-mentioned aspect (1) have ridge lines extending along the mounting face of a circuit board on the side facing said mounting face. Therefore, the position of the protruding ends of the solder connection members on the side facing the above-mentioned mounting face in a direction perpendicular to the above-mentioned mounting face is the position of the above-mentioned ridge lines. Accordingly, during an inspection to measure the degree of flatness, the protruding ends of the solder connection members are detected as lines in the images of the electrical connector for circuit boards captured from the circuit board side. Therefore, in the above-mentioned aspect (1), the range of detectable sections is widened compared to when the protruding ends of the solder connection members are detected as points, as is the case in the prior art, thereby facilitating protruding end detection and making it possible to determine the degree of flatness of the solder connection members with high accuracy.

(2) In aspect (1), the connection portions may be arranged side by side such that a direction parallel to the mounting face is the array direction, and the solder connection members may be attached to the connection portions in an orientation in which the ridge lines are perpendicular to the array direction. By doing so, the spacing between adjacent solder connection members in a row of connection portions can be increased. Therefore, in a jig used to form solder connection members, the sections that separate adjacent solder connection members can be enlarged, making it easier to ensure sufficient strength of those sections.

(3) In aspect (1) or (2), the solder connection members may have a round cylindrical shape, a polygonal cylindrical shape, a bale shape, or a barrel shape extending parallel to the mounting face.

### Technical Effect

The present invention can provide an electrical connector for circuit boards in which the degree of flatness of the solder connection members can be determined with high accuracy.

### BRIEF DESCRIPTION OF THE DRAWINGS

FIG. 1 is a perspective view of a socket connector and a plug connector according to an embodiment, showing a state prior to matingly connecting the two connectors as viewed obliquely from above.

FIG. 2 show cross-sectional views of the socket connector and plug connector taken at the location of the terminals in the terminal array direction, showing a state prior to matingly connecting the two connectors.

FIG. 3 is a cross-sectional view of the socket connector and plug connector taken at the location of the terminals in the terminal array direction, showing a state of mated connection of the two connectors.

FIGS. 4(A) and 4(B) are perspective views of a socket terminal used in the socket connector, where FIG. 4(A) shows a view from the contact surface side in a state with solder connection members attached, and FIG. 4(B) shows a view from the side opposite to the contact surface.

FIG. 5(A) is a partial enlarged view of the socket connector of FIG. 2, and FIG. 5(B) is a cross-sectional view showing a partial cross-section of the socket connector taken at the location of the terminals in the connector width direction.

FIG. 6(A) is a bottom view showing a portion of the bottom face of the socket connector in enlarged detail, and FIG. 6(B) is a bottom view showing a portion of the bottom face of the socket connector in enlarged detail.

FIG. 7 is a perspective view showing the plug connector of FIG. 1 in a vertically inverted state.

FIGS. 8(A) and 8(B) are perspective views of a plug terminal used in the plug connector, where FIG. 8(A) shows a view from the contact surface side in a state with solder connection members attached, and FIG. 8(B) shows a view from the side opposite to the contact surface.

FIG. 9(A) is a bottom view showing a portion of the bottom face of the plug connector in enlarged detail, and FIG. 9(B) is a bottom view showing a portion of the bottom face of the plug connector in enlarged detail.

FIG. 10 shows a portion of a jig used to attach solder connection members to the socket terminals and plug terminals, along with the solder connection members, where (A) is a cross-sectional view perpendicular to the axial direction of the solder connection members, and (B) is a plan view showing a state viewed from above.

FIG. 11 is a perspective view of the plug connector and the cap of FIG. 7, showing a state prior to cap mounting.

FIG. 12 is a perspective view of the plug connector and the cap of FIG. 7, showing a state after cap mounting.

FIGS. 13(A)- 13(C) shows the plug connector with the cap mounted thereto, where FIG. 13(A) is a front view as seen in the terminal array direction, FIG. 13(B) is a cross-sectional view taken at the location of a support piece in the connector width direction, and FIG. 13(C) is a cross-sectional view taken at the location of an attachment piece in the connector width direction.

FIG. 14 is a perspective view of a plug connector and a cap according to a variation, showing a state prior to cap mounting.

FIG. 15 is a cross-sectional view of the plug connector of FIG. 14 taken at the location of the terminals in the terminal array direction.

FIGS. 16(A) and 16(B) show perspective views of a plug terminal used in the plug connector of FIG. 14, where FIG. 16(A) shows a view from the contact surface side, and FIG. 16(B) shows a view from the side opposite to the contact surface.

### DETAILED DESCRIPTION

An embodiment of the present invention will be described below with reference to the accompanying drawings.

In the present embodiment, an electrical connector assembly is formed by a socket connector 1 and a plug connector 2, that is, a counterpart connector matingly connected to said socket connector 1. The plug connector 2 serves as a counterpart connector for the socket connector 1, and the socket connector 1 serves as a counterpart connector for the plug connector 2. In addition, the socket connector 1 and plug connector 2 are electrical connectors for circuit boards respectively mounted on different circuit boards (not shown).

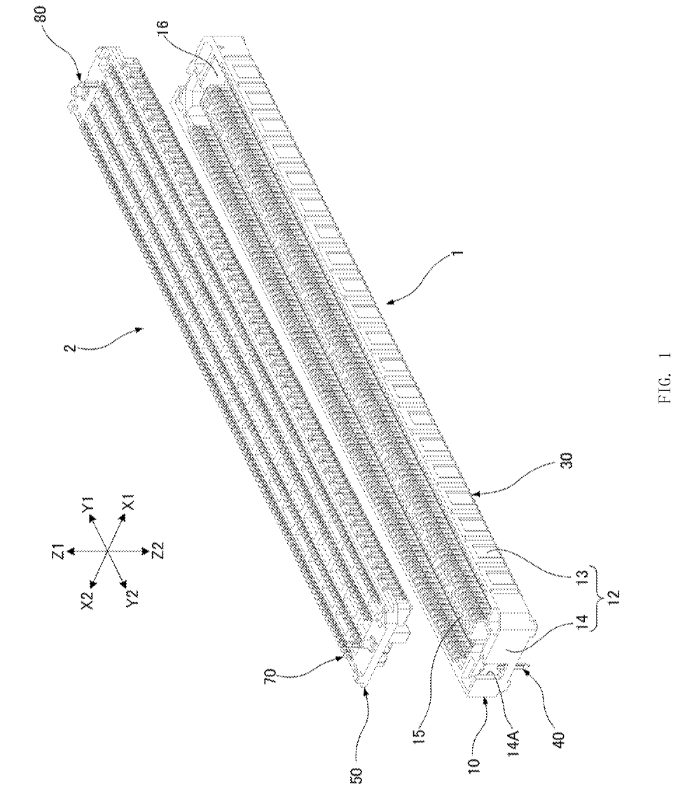

The socket connector 1 is disposed on the mounting face of a circuit board (not shown) in which said mounting face is perpendicular to the up-down direction (Z-axis direction). The plug connector 2 is disposed on the mounting face of another circuit board (not shown) in which said mounting face is perpendicular to the up-down direction (Z-axis direction). As shown in FIGS. 1-3, both connectors 1, 2 are matingly connected such that the up-down direction (Z-axis direction) is the direction of mating of the connectors while being oriented such that the two respective mounting faces of the one and the other of the circuit boards are opposed in the up-down direction. Specifically, the plug connector 2 is adapted to be matingly connected to the socket connector 1 from above. In other words, in the socket connector 1, the upper side (Z1 side) is the side that mates with the plug connector 2, whereas, in the plug connector 2, the lower side (Z2 side) is the side that mates with the socket connector 1 (counterpart mating side).

The socket connector 1 comprises a socket housing 10 made of plastics or another electrically insulating material that extends such that a direction parallel to the mounting face of the circuit board (Y-axis direction) is the longitudinal direction, a plurality of metal socket terminals 20 arranged and retained in the socket housing 10 such that said longitudinal direction is the direction of the terminal array, solder connection members 30 attached to the socket terminals 20, and two socket anchor fittings 40 retained in the socket housing 10.

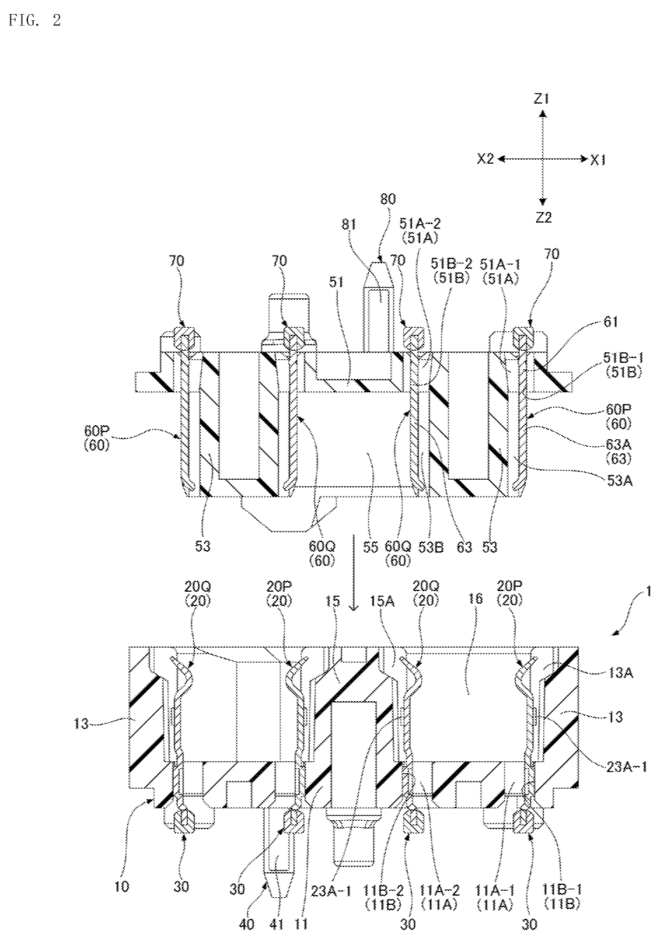

As shown in FIG. 2, in the present embodiment the socket terminals 20 are arranged side by side in four terminal rows. Hereinbelow, as appropriate, when referring to these four terminal rows, the terminal rows located at opposite ends in the connector width direction (X-axis direction), that is, the transverse direction of the socket connector 1, will be referred to as “outer terminal rows,” and the other terminal rows will be referred to as “inner terminal rows.” In addition, the socket terminals 20 that form the outer terminal rows will be referred to as “outer socket terminals 20P,” and the socket terminals 20 that form the inner terminal rows will be referred to as “inner socket terminals 20Q.”

As shown in FIG. 1, the socket housing 10 has a generally rectangular parallelepipedal external shape extending such that the terminal array direction (Y-axis direction) is the longitudinal direction, and comprises a bottom wall 11 (see FIG. 2), which is in a face-to-face relationship with the mounting face of the circuit board (not shown), as well as a peripheral wall 12 and a protruding wall 15, which extend upwardly from said bottom wall 11. The peripheral wall 12 has side walls 13, that is, two wall portions extending in the terminal array direction, and two end walls 14 extending in the connector width direction (X-axis direction) and coupling the respective end portions of the side walls 13. The protruding wall 15 is a wall portion enclosed by the peripheral wall 12 and extending in the terminal array direction. The interior space of the socket housing 10, i.e., the upwardly open annular space enclosed by the bottom wall 11, peripheral wall 12, and protruding wall 15, is formed as a receiving portion 16 used to receive a portion of the plug connector 2.

As shown in FIG. 2, a plurality of bottom holes 11A disposed through the bottom wall 11 in the up-down direction and in communication with the receiving portion 16 are formed in the bottom wall 11 at locations corresponding to the socket terminals 20. The bottom holes 11A include outer bottom holes 11A-1, which are formed in alignment with the outer terminal rows, and inner bottom holes 11A-2, which are formed in alignment with the inner terminal rows. The outer bottom holes 11A-1 and inner bottom holes 11A-2 are shaped to be inverted with respect to each other in the connector width direction (X-axis direction).

Terminal retaining portions 11B, which are retaining portions that accommodate and retain a portion of a socket terminal 20 by press-fitting, are formed in a portion of the bottom holes 11A. Among the terminal retaining portions 11B, outer terminal retaining portions 11B-1, which form part of the outer bottom holes 11A-1, are formed as slot portions located toward the outside in the connector width direction in the outer bottom holes 11A-1. Inner terminal retaining portions 11B-2, which form part of the inner bottom holes 11A-2, are formed as slot portions located toward the inside in the connector width direction in the inner bottom holes 11A-2.

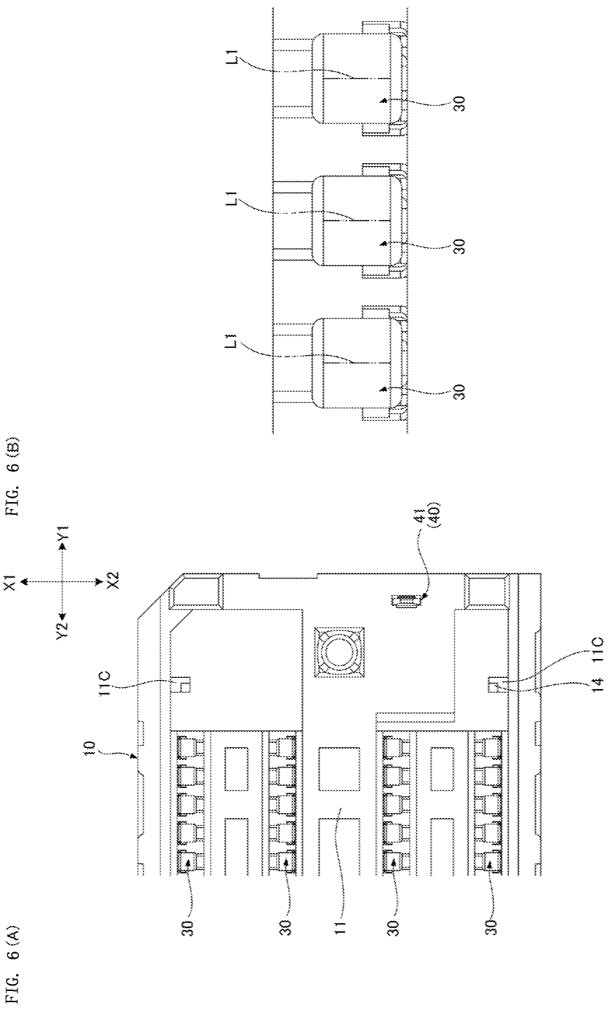

Reference holes 11C, which are disposed through the bottom wall 11 in the up-down direction, are formed in the corners of said bottom wall 11. As shown in FIG. 6 (A), the reference holes 11C are formed as holes of a quadrangular shape when viewed in the up-down direction at substantially the same locations as the outer terminal rows in the connector width direction (X-axis direction) and on opposite outer sides of the outer terminal rows in the terminal array direction (Y-axis direction). Portions of the end walls 14 are located within the range of the reference holes 11C, and said portions of the end walls 14 are visible when the reference holes 11C are viewed from below. The positions of the portions of the end walls 14 visible through the reference holes 11C serve as reference positions used during an inspection to check the position of the solder connection members 30, as described below.

Outer receiving slot portions 13A (see FIG. 2) capable of accommodating a portion of the outer socket terminals 20P are formed in the side walls 13 in a side-by-side arrangement in the terminal array direction. As shown in FIG. 2, the outer receiving slot portions 13A, which extend in the up-down direction while being recessed into the inner surfaces of the side walls 13 (surfaces facing the receiving portion 16), have open top ends. In addition, the top portions of the outer receiving slot portions 13A are recessed deeper than other portions.

As shown in FIG. 1, fitting retaining portions 14A used to retain the socket anchor fittings 40 by press-fitting are formed in the end walls 14. The fitting retaining portions 14A are formed in the end walls 14 at locations proximate to the X2 side in the connector width direction (X-axis direction) as slot portions disposed through the end walls 14 in the up-down direction.

Inner receiving slot portions 15A capable of accommodating a portion of the inner socket terminals 20Q (see FIG. 2) are formed in a side-by-side arrangement in the terminal array direction in the protruding wall 15. As shown in FIG. 2, the inner receiving slot portions 15A are shaped by inverting the outer receiving slot portions 13A in the connector width direction. In other words, the inner receiving slot portions 15A, which extend in the up-down direction while being recessed into the outer surfaces of the protruding wall 15 (surfaces facing the receiving portion 16), have open top ends. In addition, the top portions of the inner receiving slot portions 15A are recessed deeper than other portions.

As previously discussed, the socket terminals 20 include the outer socket terminals 20P, which form the outer terminal rows, and the inner socket terminals 20Q, which form the inner terminal rows. The outer socket terminals 20P and inner socket terminals 20Q are identical in shape. The configuration of the socket terminals 20 will be described herein without making a distinction between the outer socket terminals 20P and inner socket terminals 20Q.

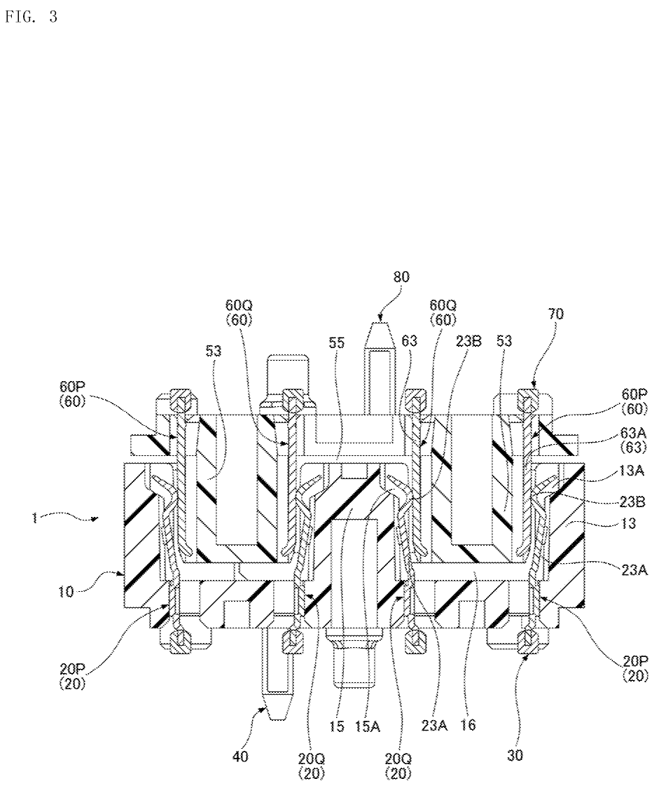

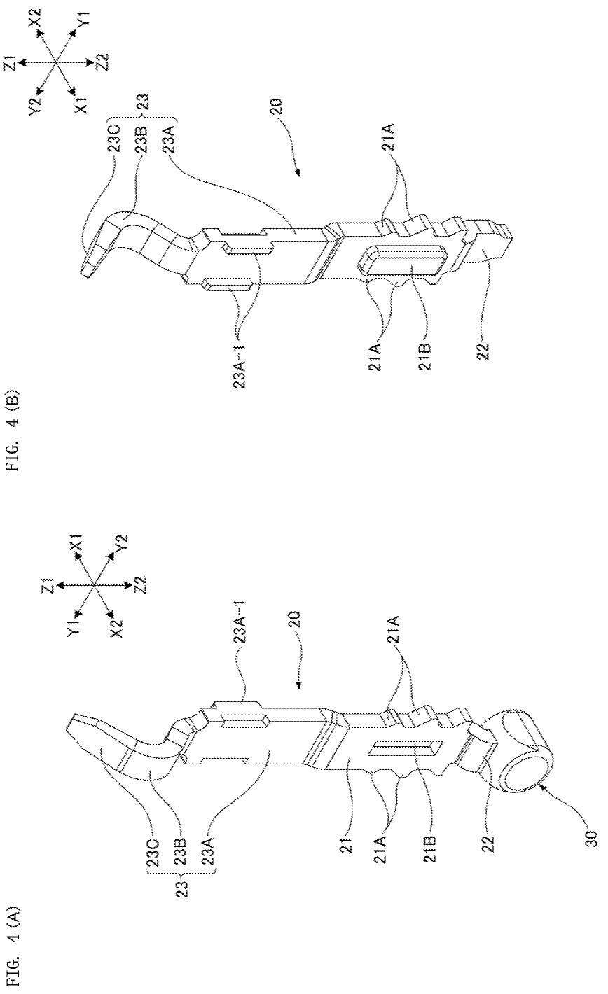

As shown in FIGS. 4(A) and 4(B), the socket terminals 20 are made by bending a vertically extending sheet metal member in the through-thickness direction. The socket terminals 20 have a retained portion 21 provided in the vertically intermediate area, a connection portion 22 that extends downwardly from the retained portion 21, and an arm portion 23 that extends upwardly from the retained portion 21. The socket terminals 20 are adapted to use a protruding curved surface formed on one major face (major face on the X2 side in FIGS. 4 (A, B)) as a contact surface and make contact with the plug terminals 60 of the plug connector 2 using said contact surface as shown in FIG. 3. As referred to herein, “one major face” is the internal major face in the connector width direction in the outer socket terminals 20P and the external major face in the connector width direction in the inner socket terminals 20Q.

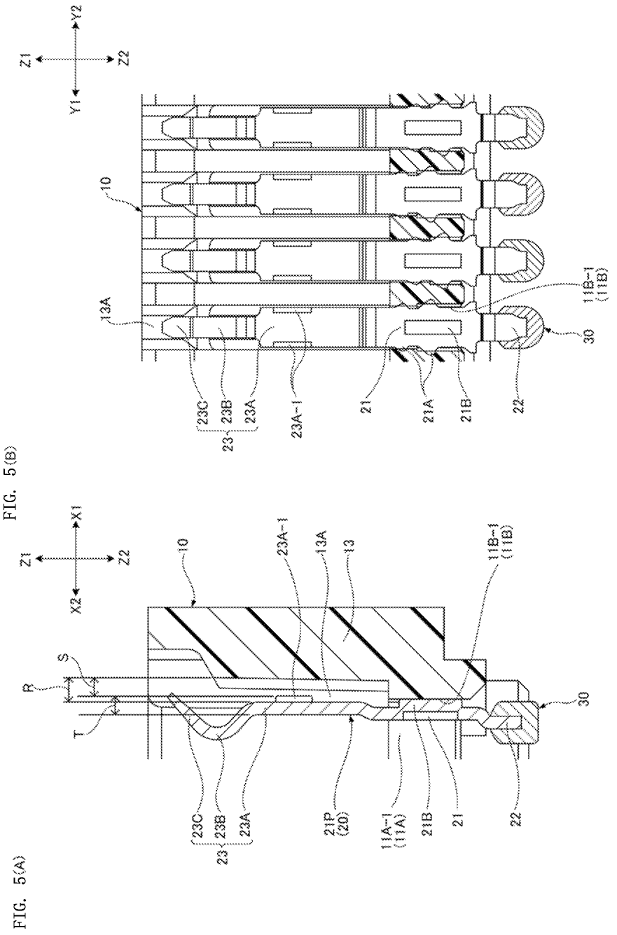

As shown in FIGS. 4(A) and 4(B), the retained portion 21 has press-fit portions 21A protruding outwardly in the terminal width direction (Y-axis direction) from the side edges on opposite sides (edges extending in the up-down direction). A plurality of press-fit portions 21A are provided in the up-down direction on the respective side edges. As shown in FIG. 5(B), as a result of being press-fitted into the terminal retaining portions 11B of the socket housing 10 from below and causing the press-fit portions 21A to bite into the inner surfaces on opposite sides of the terminal retaining portions 11B in the terminal width direction, the retained portions 21 are retained by the terminal retaining portions 11B. As shown in FIG. 5(B), in the present embodiment, the press-fit portions 21A of adjacent socket terminals 20 are provided at positions offset from each other in the up-down direction.

The retained portions 21 have a positioning portion 21B used for precise positioning of said retained portions 21 in the through-thickness direction (X-axis direction). The positioning portion 21B, which is formed, for example, by embossing, extends in the up-down direction while protruding from the other major face, i.e., from the major face on the side opposite to the major face on which the contact surface is formed, at a central location in the terminal width direction (Y-axis direction). As shown in FIG. 2, the positioning portion 21B protrudes outwardly in the terminal array direction in the outer socket terminals 20P and protrudes inwardly in the terminal array direction in the inner socket terminals 20Q. The retained portions 21 are precisely positioned in the through-thickness direction (X-axis direction) because the positioning portions 21B abut the inner surface of the terminal retaining portions 11B (surface perpendicular to the X-axis direction) with the protruding apical faces thereof.

As shown in FIGS. 4(A), 4(B) and 5(A), after bending in a crank-like configuration at the bottom end of the retained portion 21, the connection portion 22 extends downwardly in a rectilinear configuration. Solder connection members 30 are attached to the connection portions 22, and the connection portions 22 are thereby connected to the circuitry of the circuit board (not shown) via said solder connection members 30.

As shown in FIG. 2, the arm portions 23 are positioned such that gaps are formed between them and a wall portion of the socket housing 10 in the through-thickness direction (X-axis direction) and extend in the up-down direction along said wall portions. Here, a “wall portion” refers to the side wall 13 with respect to the arm portions 23 of the outer socket terminals 20P and refers to the protruding wall 15 with respect to the arm portions 23 of the inner socket terminals 20Q. As shown in FIGS. 2 and 5(A), in a free state, the arm portions 23 have parts thereof in the through-thickness direction located within the corresponding receiving slot portions 13A, 15A. As shown in FIG. 5(B), the dimensions (terminal width dimensions) of the arm portions 23 in the terminal width direction (Y-axis direction) are smaller than the maximum terminal width dimensions of the retained portions 21, i.e., the distance between the two apical portions of the press-fit portions 21A in the terminal width direction. Forming the arm portions 23 in this manner of smaller width dimensions than the maximum terminal width dimensions of the retained portions 21 makes it possible to introduce the socket terminals 20 into the socket housing 10 from the side of the bottom wall 11, i.e., from below, and press-fit them using the retained portions 21.

The arm portions 23 have a resilient portion 23A extending from the top end of the retained portion 21, a contact portion 23B extending from the top end of the resilient portion 23A, and an inclined portion 23C extending from the top end of the contact portion 23B. As shown in FIGS. 4(A), 4(B), and 5(A), after bending in a crank-like configuration at the top end of the retained portion 21, the resilient portion 23A extends upwardly in a rectilinear configuration and is resiliently displaceable in the through-thickness direction (X-axis direction). The terminal width dimensions of the resilient portion 23A are slightly smaller than the dimensions (slot width dimensions) of the receiving slot portions 13A, 15A in the terminal width direction.

In addition, as shown in FIGS. 4(A) and 4(B), protrusions 23A-1 are formed in the top portion of the resilient portion 23A, in both side portions thereof in the terminal width direction. The protrusions 23A-1, which are formed, for example, by embossing, extend in the up-down direction while protruding from the other major face, i.e., from the major face on the side opposite to the major face on which the contact surface is formed. As shown in FIG. 2, the protrusions 23A-1 protrude outwardly in the terminal array direction in the outer socket terminals 20P and protrude inwardly in the terminal array direction in the inner socket terminals 20Q. The protrusions 23A-1 are located in the direction (X-axis direction) facing the corresponding wall portion (a side wall 13 for the outer socket terminals 20P, and the protruding wall 15 for the inner socket terminals 20Q) within the range of a gap R with said wall portion. In addition, the protruding apical faces of the protrusions 23A-1 have a gap S formed between them and the corresponding wall portion, and the resilient portion 23A is resiliently displaceable in the through-thickness direction within the range of the gap S. An example of an outer socket terminal 20P in FIG. 5(A) shows a gap R and a gap S formed with a side wall 13 (wall portion).

In the present embodiment, as a result of providing the protrusion 23A-1 in the resilient portion 23A, the dimension T of the resilient portion 23A in the through-thickness direction at the location of the protrusion 23A-1 (see FIG. 5(A)), as seen when the resilient portion 23A is viewed in the terminal width direction (Y-axis direction), that is, the distance between the major face (the one major face) of the resilient portion 23A on the X2 side in the through-thickness direction and the protruding apical face of the protrusion 23A-1, is increased compared to when no protrusion is formed. Therefore, even under the constraint that the arm portion 23 be formed of smaller terminal width dimensions than those of the retained portion 21, the increase in impedance can be minimized by using the above-mentioned gap R as described above to provide a protrusion 23A-1 and make the above-mentioned dimension T sufficiently large.

As shown in FIG. 5(B), the contact portions 23B have smaller, i.e., narrower, terminal width dimensions than the resilient portions 23A. The contact portions 23B, which are bent in the through-thickness direction such that the one major face forms a protruding curved surface, use this protruding curved surface as a contact surface contactable with the plug terminals 60 of the plug connector 2. As shown in FIG. 5(B), the inclined portions 23C are formed of the same terminal width dimensions as the contact portions 23B. The inclined portions 23C, which extend so as to incline toward the side opposite to the contact surface as they extend upward from the top ends of the contact portions 23B, have their distal ends located within the receiving slot portions 13A, 15A. In the process of mating with the plug connector 2, the inclined portions 23C function as guiding portions for guiding the plug terminals 60 to the standard contact position.

As shown in FIG. 4(A), the solder connection members 30 are formed in a barrel shape with an axis extending in a direction perpendicular to the terminal array direction (Y-axis direction). In the solder connection members 30, the surface on the bottom side, i.e., the surface facing toward the mounting face side of the circuit board, is a protruding curved surface having a ridge line L1 extending in the X-axis direction (see FIG. 6(B)). Therefore, in each terminal row, solder connection members 30 that are adjacent to each other in the terminal array direction, in other words, in the array direction of the connection portions 22 (Y-axis direction), have ridge lines L1 that are parallel to each other as shown in FIG. 6(B).

The socket anchor fittings 40 are made by punching out sheet metal members, and, as shown in FIG. 1, are retained in the fitting retaining portions 14A of the socket housing 10 in an orientation in which the major faces thereof are perpendicular to the terminal array direction (Y-axis direction). Specifically, the socket anchor fittings 40 are press-fitted into the fitting retaining portions 14A from the mating side (from above in FIG. 1) and retained by the opposite side edges thereof (edges extending in the up-down direction). In addition, as shown in FIGS. 1 and 2, the socket anchor fittings 40, which have an anchor leg portion 41 extending downwardly of the bottom face of the socket housing 10, are solder-secured to the circuit board by means of the anchor leg portion 41.

The socket connector 1 is assembled in accordance with the following procedure. First, the socket terminals 20 are press-fittingly attached to the socket housing 10 from below. Specifically, after inserting the arm portions 23 of the socket terminals 20 into the bottom holes 11A from below, the retained portions 21 are press-fitted into the terminal retaining portions 11B from below.

Next, the socket anchor fittings 40 are attached to the socket housing 10 by press-fitting into the fitting retaining portions 14A from above. Next, the solder connection members 30 are attached to the connection portions 22 of the socket terminals 20. The attachment step of the solder connection members 30 will be described below. It should be noted that the attachment step of the socket anchor fittings 40 may be performed prior to the attachment step of the socket terminals 20. Furthermore, the attachment step of the solder connection members 30 may be performed prior to the attachment step of the socket anchor fittings 40.

The plug connector 2 comprises a plug housing 50 made of plastics or another electrically insulating material that extends such that a direction parallel to the mounting face of the circuit board (Y-axis direction) is the longitudinal direction, a plurality of metal plug terminals 60 arranged and retained in the plug housing 50 such that said longitudinal direction is the direction of the terminal array, solder connection members 70 attached to the plug terminals 60, and two plug anchor fittings 80 retained in the plug housing 50.

As shown in FIG. 2, in the present embodiment the plug terminals 60 are arranged side by side in four terminal rows in alignment with the socket terminals 20 of the socket connector 1. Hereinbelow, in the same manner as with the previously discussed socket terminals 20, as appropriate, when referring to these four terminal rows, the terminal rows located at opposite ends in the connector width direction (in the transverse direction of the plug connector 2) will be referred to as “outer terminal rows,” and the other terminal rows will be referred to as “inner terminal rows.” In addition, the plug terminals 60 forming the outer terminal rows will be referred to as “outer plug terminals 60P,” and the plug terminals 60 forming the inner terminal rows will be referred to as “inner plug terminals 60Q.”

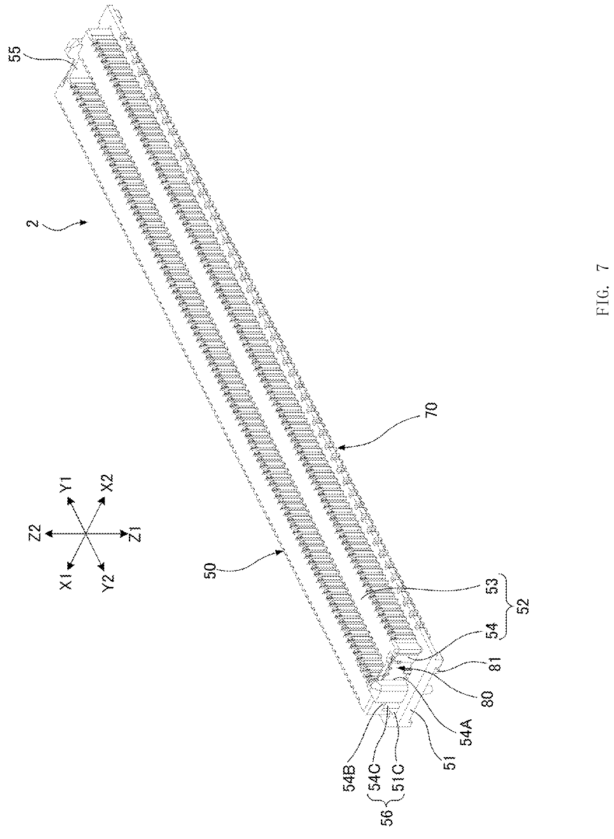

As shown in FIG. 1, the plug housing 50 has a generally rectangular parallelepipedal external shape extending such that the terminal array direction (Y-axis direction) is the longitudinal direction, and comprises a bottom wall 51, which is in a face-to-face relationship with the mounting face of the circuit board (not shown), and a peripheral wall 52, which extends downwardly from said bottom wall 51. FIG. 7 is a perspective view showing the plug connector 2 of FIG. 1 in a vertically inverted configuration. As shown in FIG. 7, the peripheral wall 52 has side walls 53, that is, two wall portions extending in the terminal array direction, and two end walls 54 extending in the connector width direction (X-axis direction) and coupling the respective end portions of the side walls 53. The interior space of the plug housing 50, that is, the upwardly open space in FIG. 7 (downwardly open in FIG. 1) enclosed by the bottom wall 51 and peripheral wall 52, is formed as a receiving portion 55 for receiving the protruding wall 15 of the socket connector 1.

As shown in FIG. 7, the bottom wall 51 has the peripheral edge thereof protruding beyond the peripheral wall 52 in the terminal array direction as well as in the connector width direction. As shown in FIG. 2, a plurality of bottom holes 51A disposed through the bottom wall 51 in the up-down direction are formed in the bottom wall 51 at locations corresponding to the plug terminals 60. The bottom holes 51A include outer bottom holes 51A-1, which are formed in alignment with the outer terminal rows, and inner bottom holes 51A-2, which are formed in alignment with the inner terminal rows. The outer bottom holes 51A-1 are formed outwardly of the side walls 53 in the connector width direction. The inner bottom holes 51A-2, which are formed inwardly of the side walls 53 in the connector width direction, are in communication with the receiving portion 55. The shapes of the outer bottom holes 51A-1 and inner bottom holes 51A-2 are inverted with respect to each other in the connector width direction.

As shown in FIG. 2, portions of the bottom holes 51A form terminal retaining portions 51B that serve as retaining portions for accommodating and press-fittingly retaining portions of the plug terminals 60. The terminal retaining portions 51B include outer terminal retaining portions 51B-1, which are formed as slot portions retaining the outer plug terminals 60P, and inner terminal retaining portions 51B-2, which are formed as slot portions retaining the inner plug terminals 60Q.

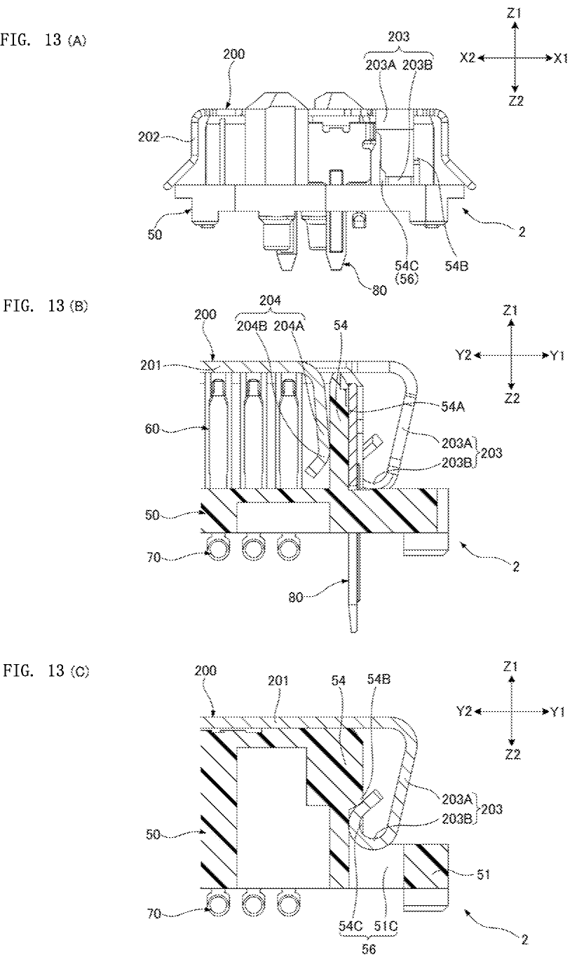

As shown in FIG. 13(C), in the bottom wall 51, downwardly of the hereinafter-described notched portions 54C provided in the end walls 54, there are formed end holes 51C that extend through the bottom wall 51 in the up-down direction and communicate with the notched portions 54C. The end holes 51C are formed outwardly of the notched portions 54C in the terminal array direction (Y-axis direction).

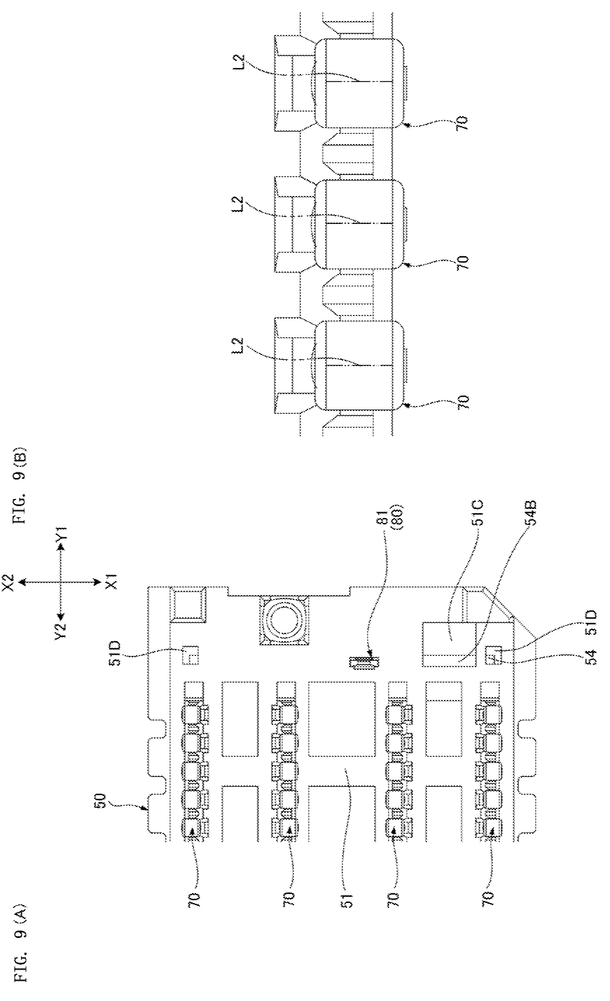

Reference holes 51D, which extend through the bottom wall 51 in the up-down direction, are formed in the corners of the bottom wall 51. As shown in FIG. 9(A), the reference holes 51D are formed as holes of a quadrangular shape when viewed in the up-down direction (Z-axis direction) at substantially the same locations as the outer terminal rows in the connector width direction (X-axis direction) and on opposite outer sides of the outer terminal rows in the terminal array direction (Y-axis direction). Portions of the end walls 54 are located within the range of the reference holes 51D, with said portions being visible when the reference holes 51D are viewed from below (from above in FIG. 1). The position of the portions of the end walls 54 visible through the reference holes 51D serves as a reference position used during an inspection to check the position of the solder connection members 70 as described below.

As shown in FIG. 2, in the side walls 53, there are formed outer receiving slot portions 53A, which can accommodate a portion of the outer plug terminals 60P, and inner receiving slot portions 53B, which can accommodate a portion of the inner plug terminals 60Q. The outer receiving slot portions 53A, which extend in the up-down direction while being recessed from the outer surface of the side walls 53, have open bottom ends (top ends in FIG. 7). The inner receiving slot portions 53B, which extend in the up-down direction while being recessed from the inner surface of the side walls 53, have open bottom ends (top ends in FIG. 7). The shapes of the outer receiving slot portions 53A and inner receiving slot portions 53B are inverted with respect to each other in the connector width direction.

In the end walls 54, there are formed fitting retaining portions 54A for retaining the plug anchor fittings 80 by press-fitting, and lockingly engageable portions 54B for attaching the hereinafter-described cap 200. As shown in FIG. 7, in the end wall 54 located on the Y2 side, a fitting retaining portion 54A is provided at a location proximate to the X2 side in the connector width direction. On the other hand, in the end wall 54 located on the Y1 side, a fitting retaining portion 54A is provided at a location proximate to the X1 side in the connector width direction. The fitting retaining portions 54A are formed as slot portions disposed through the end walls 54 in the up-down direction.

As shown in FIG. 7, in the end wall 54 located on the Y2 side, a lockingly engageable portion 54B is provided at a location proximate to the X1 side in the connector width direction. In the end wall 54 located on the Y1 side as well, a lockingly engageable portion 54B is provided at a location proximate to the X1 side in the connector width direction.

As shown in FIG. 13(C), the lockingly engageable portions 54B are formed as stepped portions above the notched portions 54C formed by making a cutout in the outer surface of the bottom portion of the end walls 54. In addition, the notched portions 54C communicate with the end holes 51C of the bottom wall 51 and form one space with said end holes 51C. This space functions as a hole 56 for receiving the hereinafter-described locking engagement portions 203B of the cap 200.

The plug terminals 60 include the outer plug terminals 60P, which form the outer terminal rows, and the inner plug terminals 60Q, which form the inner terminal rows. The configuration of the plug terminals 60 will be described herein without making a distinction between the outer plug terminals 60P and the inner plug terminals 60Q.

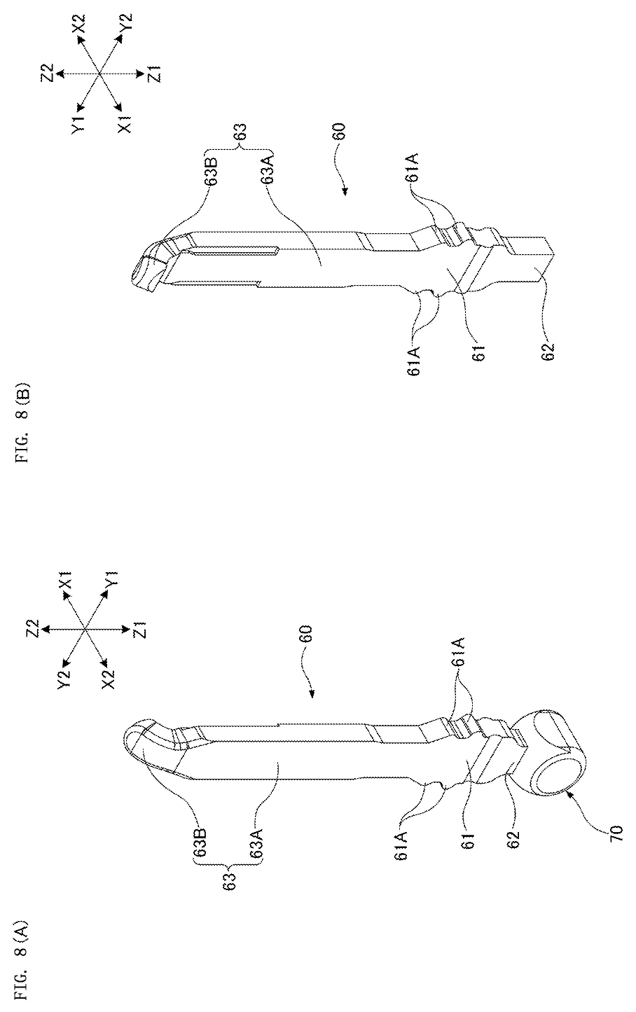

As shown in FIGS. 8(A) and 8(B), the plug terminals 60 are made by bending a vertically extending sheet metal member in the through-thickness direction. The plug terminals 60 have a retained portion 61 provided in the vertically intermediate area, a connection portion 62 that extends downwardly (upwardly in FIG. 2) from the retained portion 61, and an arm portion 63 that extends upwardly (downwardly in FIG. 2) from the retained portion 61. As shown in FIG. 3, the plug terminals 60 are adapted to make contact with the socket terminals 20 of the socket connector 1 using a contact surface formed on the one major face (major face on the X2 side in FIGS. 8(A) and 8(B). As referred to herein, “one major face” is the external major face in the connector width direction in the outer plug terminals 60P and the internal major face in the connector width direction in the inner plug terminals 60Q.

As shown in FIGS. 8(A) and 8(B), the retained portion 61 has press-fit portions 61A protruding outwardly in the terminal width direction (Y-axis direction) from the side edges on opposite sides (edges extending in the up-down direction). A plurality of press-fit portions 61A is provided in the up-down direction on the respective side edges. As shown in FIG. 2, as a result of being press-fitted into the terminal retaining portions 51B of the plug housing 50 from above (from below in FIG. 7) and causing the press-fit portions 61A to bite into the inner surfaces on opposite sides of the terminal retaining portions 51B in the terminal width direction, the retained portions 61 are retained by the terminal retaining portions 51B. In the present embodiment, the press-fit portions 61A of adjacent plug terminals 60 are provided at positions offset from each other in the up-down direction.

As shown in FIGS. 8(A) and 8(B), after bending in a crank-like configuration at the bottom end of the retained portion 61, the connection portion 62 extends downwardly in a rectilinear configuration. Solder connection members 70 are attached to the connection portions 62, and the connection portions 62 are thereby connected to the circuitry of the circuit board (not shown) via said solder connection members 70.

As shown in FIG. 2, the arm portions 63 are positioned such that gaps are formed between them and the side walls 53 of the plug housing 50 in the through-thickness direction (X-axis direction), and extend in the up-down direction along said side walls 53. The dimensions of the arm portions 63 in the terminal width direction (Y-axis direction) (terminal width dimensions) are smaller than the maximum terminal width dimensions of the retained portions 61, i.e., the distance between the two apical portions of the press-fit portions 61A in the terminal width direction. As shown in FIG. 8 (A, B), the arm portions 63 have a contact portion 63A extending upwardly in a rectilinear manner from the top end of the retained portion 61, and an inclined portion 63B extending in a curved configuration from the top end of the contact portion 63A. The contact portions 63A use the one major face (the external major face in the outer plug terminals 60P and the internal major face in the inner plug terminals 60Q) as a contact surface contactable with the contact portions 23B of the socket terminals 20. As shown in FIG. 8(A) and FIG. 8(B), the inclined portions 63B, which extend so as to incline toward the side opposite to the contact surface as they extend upward from the top ends of the contact portions 63A, have their distal ends located within the receiving slot portions 53A, 53B. In the process of mating with the socket connector 1, the inclined portions 63B function as guiding portions for guiding the socket terminals 20 to the standard contact position.

The solder connection members 70 are formed of the same shape as the solder connection members 30 attached to the socket terminals 20. In other words, as shown in FIG. 8(A), the solder connection members 70 are formed in a barrel shape with an axis extending in a direction (X-axis direction) perpendicular to the terminal array direction (Y-axis direction). In the solder connection members 70, the surface on the bottom side in FIG. 8(A), i.e., the surface facing toward the mounting face side of the circuit board, is a protruding curved surface having a ridge line L2 extending in the X-axis direction (see FIG. 9(B)). Therefore, in each terminal row, solder connection members 70 that are adjacent to each other in the terminal array direction, in other words, in the array direction of the connection portions 62 (Y-axis direction), have ridge lines L2 that are parallel to each other as shown in FIG. 9(B).

The plug anchor fittings 80 are made by punching out sheet metal members, and, as shown in FIG. 1, are retained in fitting retaining portions 54A in the plug housing 50 in an orientation in which the major faces thereof are perpendicular to the terminal array direction (Y-axis direction). Specifically, the plug anchor fittings 80 are press-fitted into the fitting retaining portions 54A from the counterpart mating side (from above in FIG. 7) and retained by the opposite side edges thereof (edges extending in the up-down direction). In addition, as shown in FIG. 7, the plug anchor fittings 80, which have an anchor leg portion 81 extending downwardly of the bottom face of the plug housing 50, are solder-secured to the circuit board by means of the anchor leg portion 81.

The plug connector 2 is assembled in accordance with the following procedure. First, the plug terminals 60 are press-fittingly attached to the plug housing 50 from below in FIG. 7. Specifically, after inserting the arm portions 63 of the plug terminals 60 into the bottom holes 51A from below, the retained portions 61 are press-fitted into the terminal retaining portions 51B from below.

Next, the plug anchor fittings 80 are attached to the plug housing 50 by press-fitting into the fitting retaining portions 54A from above in FIG. 7. Next, the solder connection members 70 are attached to the connection portions 62 of the plug terminals 60. It should be noted that the attachment step of the plug anchor fittings 80 may be performed prior to the attachment step of the plug terminals 60. In addition, the attachment step of the solder connection members 70 may be performed prior to the attachment step of the plug anchor fittings 80.

As previously discussed, in the socket connector 1, the solder connection members 30 are attached to the connection portions 22 of the socket terminals 20, and in the plug connector 2, the solder connection members 70 are attached to the connection portions 62 of the plug terminals 60. Since the solder connection members 30 and solder connection members 70 are attached in the same manner, the procedure for attaching the solder connection members 30 will be described herein, and a description of the procedure for attaching the solder connection members 70 will be omitted.

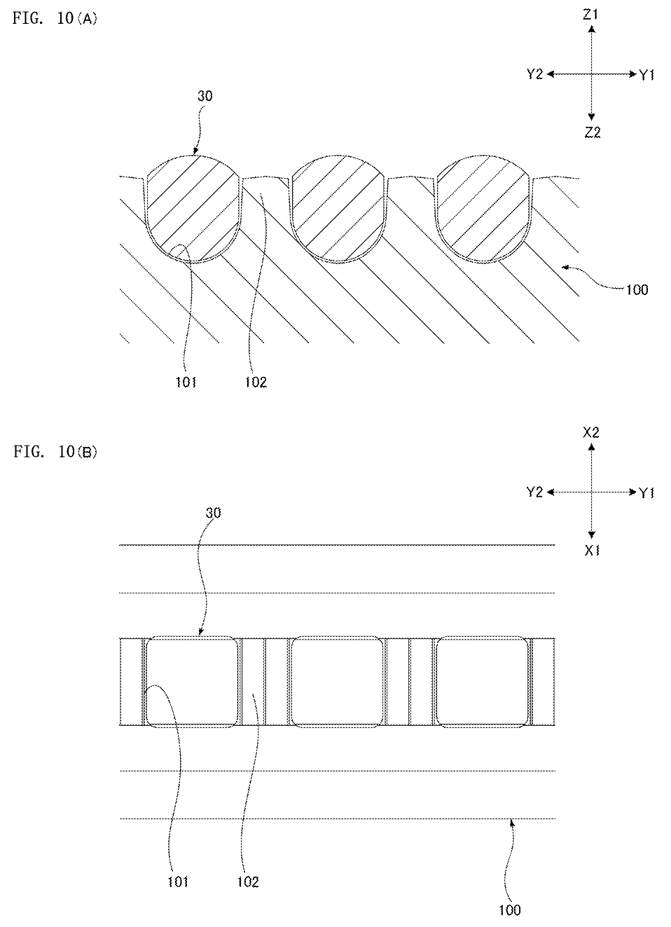

In the present embodiment, the operation for attaching the solder connection members 30 is performed using the jig 100 shown in FIG. 10. As shown in FIG. 10(A) and FIG. 10(B), a plurality of recesses 101 used to accommodate the solder connection members 30 are formed in the top portion of the jig 100 in a side-by-side arrangement at equal intervals in the terminal array direction so as to correspond to the position of the connection portions 22 of the socket terminals 20. As shown in FIG. 10(A), the recesses 101, while being recessed from the top face of the jig 100, extend in a uniform manner across the full extent thereof in the X-axis direction. The inner surface of the bottom side of the recesses 101 is formed as a concave curved surface. This concave curved surface is shaped to match the protruding curved surface on the bottom side of the solder connection members 30. In addition, the inner surface of the top portion of the recesses 101 is a flat surface extending in the up-down direction. Adjacent recesses 101 are separated from each other by a partition wall 102.

When attaching the solder connection members 30 to the connection portions 22 of the socket terminals 20, first, a single ball of solder material (not shown) is received within each recess 101 from above. The jig 100 and the solder material are then heated in a reflow oven (not shown) to thereby melt said solder material. Next, the socket connector 1 is lowered onto the jig 100 from above, and the connection portions 22 of the socket terminals 20 are introduced into the respective corresponding recesses 101 from above. As a result, the connection portions 22 are introduced into the molten solder material.

Next, the process of heating in the reflow oven is terminated and the assembly is cooled to solidify the solder material. As a result, the solder material is molded to form barrel-shaped solder connection members 30 within the recesses 101, and said solder connection members 30 are attached to the connection portions 22. The socket connector 1 is then moved upwardly and the connection portions 22 are removed from the recesses 101 along with the solder connection members 30. This completes the operation for attaching the solder connection members 30.

Before being mounted on a circuit board, the socket connector 1 having the solder connection members 30 attached to the connection portions 22 undergoes an inspection to check the position of the solder connection members 30 within a plane (the XY plane) parallel to the connector width direction (X-axis direction) and the terminal array direction (Y-axis direction). During such an inspection, images of the socket connector 1 are captured from below using a camera or the like, and the position of the bottom ends (lower protruding ends) of the solder connection members 30 in the XY plane is detected based on the captured images. At such time, the position of the bottom end in each solder connection member 30 is detected based on the distance from the position of the portion of the end wall 14 visible through the reference holes 11C (see FIG. 6(A)).

In addition, before being mounted on a circuit board, the socket connector 1 having the solder connection members 30 attached to the connection portions 22 undergoes an inspection to determine the degree of flatness of the solder connection members 30. During such an inspection, images of the socket connector 1 are captured from below using a camera or the like, and the vertical position of the bottom ends (lower protruding ends) of the solder connection members 30 is detected based on the captured images. The degree of flatness is then determined based on the extent of variation in the position of the bottom end in all solder connection members 30.

Furthermore, before being mounted on a circuit board, the plug connector 2 having the solder connection members 70 attached to the connection portions 62 undergoes an inspection, following the same procedure as described above for the socket connector 1, to check the position of the solder connection members 70 within the XY plane and an inspection to determine the degree of flatness of the solder connection members.

In the present embodiment, the position of the bottom ends of the solder connection members 30, 70 is the position of the ridge lines L1, L2 (see FIG. 6(B) and FIG. 9(B)). Accordingly, in the images of the connectors 1, 2 captured during the above-mentioned inspections, the bottom ends of the solder connection members 30, 70 are detected as lines. Therefore, in the present embodiment, the range of detectable sections is widened compared to when the bottom ends of the solder connection members are detected as points, as is the case in the prior art, which facilitates bottom end detection and makes it possible to pinpoint the position of the solder connection members 30, 70 within the XY plane and determine the degree of flatness of the solder connection members 30, 70 in a highly accurate manner.

In the present embodiment, the ridge lines L1, L2 of the solder connection members 30, 70 extend in the X-axis direction, which is perpendicular to the terminal array direction, in other words, to the array direction of the solder connection members 30, 70 in each terminal row. Providing the solder connection members 30, 70 in this manner in an orientation in which the ridge lines L1, L2 extend in the X-axis direction makes it possible to increase the intervals between adjacent solder connection members 30, 70 in the above-mentioned array direction. Therefore, in the jig 100, the partition walls 102 located so as to correspond to the above-mentioned intervals can be made larger, thereby making it easier to ensure sufficient strength in said partition walls 102.

Although in the present embodiment the solder connection members 30, 70 are assumed to have a barrel shape, the shape of the solder connection members is not limited thereto, and any shape is acceptable as long as the solder connection members have ridge lines on the side facing the mounting face of the circuit board. Accordingly, the solder connection members may have, for example, a round cylindrical shape, a polygonal cylindrical shape, a bale shape, and the like. In addition, if the solder connection members are of a polygonal cylindrical shape, their cross-section perpendicular to the axis may be rectangular or trapezoidal, and among other shapes, may include shapes having a V-shaped section protruding toward the side facing the mounting face of the circuit board. In addition, the number of the ridge lines on the solder connection members may be two or more.

In addition, although in the present embodiment the solder connection members 30, 70 are assumed to be provided in an orientation in which the ridge lines L1, L2 are perpendicular to the terminal array direction, the orientation of the solder connection members 30, 70 is not limited thereto. Namely, it is sufficient for the solder connection members to be provided in an orientation as long as the ridge lines extend along the mounting face of the circuit board.

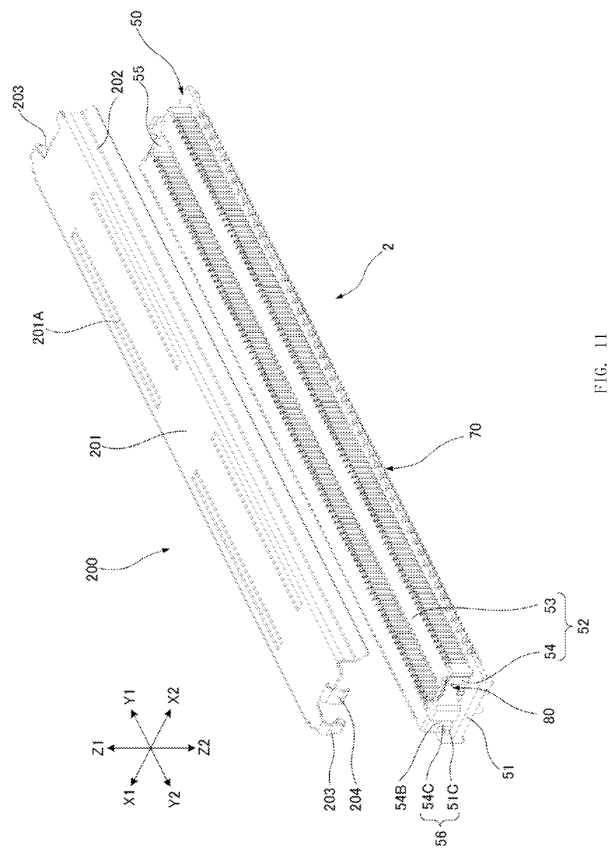

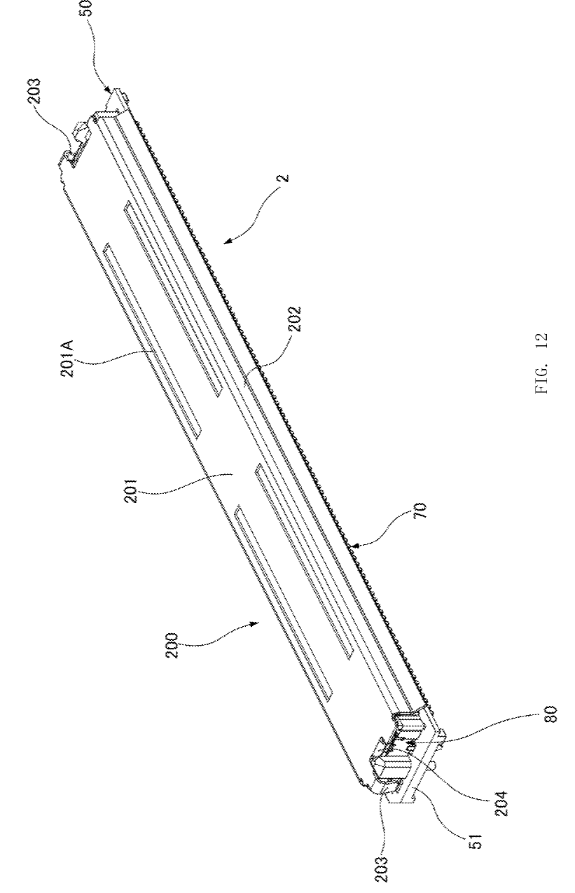

As a result of being placed on the mounting face of a circuit board and heated in a reflow oven along with the circuit board, the socket connector 1 and the plug connector 2, with the metal cap attached thereto, are mounted to the mounting face through solder connections. FIGS. 11 and 12 are perspective views showing a plug connector 2 along with a cap 200 intended for use with said plug connector 2, where FIG. 11 shows a state prior to the attachment of the cap 200, and FIG. 12 shows a state with the cap 200 attached.

As shown in FIGS. 11 and 12, the cap 200, which is made by bending a sheet metal member in the through-thickness direction, is attached to the plug connector 2 from above. The cap 200 comprises a cover plate portion 201, whose major face is perpendicular to the up-down direction, side plate portions 202, which are bent and extend downwardly at both side edges (edges extending in the terminal array direction) of the cover plate portion 201, as well as attachment pieces 203 and support pieces 204, which are bent and extend downwardly at both end edges (edges extending in the connector width direction) of the cover plate portion 201.

As shown in FIGS. 11 and 12, the cover plate portion 201 is formed of a planar configuration extending in the terminal array direction and covering the top face of the peripheral wall 52 and the opening of the receiving portion 55 from above. When transporting the plug connector 2 to the mounting face of the circuit board, the top face of the cover plate portion 201 serves as a suction face picked up by a suction device (not shown). In addition, a plurality of heat dissipation holes 201A used for heat dissipation during reflow soldering are formed in the cover plate portion 201. The heat dissipation holes 201A, which have a rectangular shape extending in the terminal array direction, are disposed through the cover plate portion 201 in the through-thickness direction.

The side plate portions 202 extend across the full range of the cover plate portion 201 in the terminal array direction as well as all the way to the location of the bottom wall 51 in the up-down direction. Therefore, as shown in FIG. 12, in the outer plug terminals 60P, all sections that are exposed on the outer surface of the side walls 53 are adapted to be covered by the side plate portions 202. In addition, the bottom portions of the side plate portions 202, which are bent so as to slope toward the outside in the connector width direction, are adapted such that said bottom portions do not interfere with the bottom wall 51.

As shown in FIGS. 12, 13 and 14, the attachment pieces 203 extend downwardly from the end edges of the cover plate portion 201 at locations on the X1 side in the connector width direction in the cover plate portion 201. As shown in FIGS. 13(A)-13(C), the attachment pieces 203 have an attachment base portion 203A, which forms the top portion thereof, and a locking engagement portion 203B, which forms the bottom portion thereof, and are resiliently displaceable in the through-thickness direction (X-axis direction) with the section coupled to the cover plate portion 201, i.e., the top end portion of the attachment base portion 203A, serving as a fulcrum. As shown in FIGS. 13(B) and 13(C), when an attachment piece 203 is viewed in the connector width direction, the attachment base portion 203A extends at an inward incline in the terminal array direction (Y-axis direction) as it extends downward. In addition, the locking engagement portion 203B extends from the bottom end of the attachment base portion 203A in the same direction as said attachment base portion 203A and is folded back upward, thereby having a substantially U-shaped configuration when viewed in the connector width direction.

As shown in FIG. 13(A), in the present embodiment, the width dimensions of the locking engagement portion 203B in the connector width direction (X-axis direction) are smaller than those of the attachment base portion 203A. By forming the locking engagement portions 203B with smaller width dimensions than those of the attachment base portions 203A, the width dimensions of the holes 56 (end holes 51C and notched portions 54C) receiving said locking engagement portions 203B can be reduced, thereby suppressing a decrease in the strength of the bottom wall 51 and the end walls 54. In addition, in the attachment pieces 203, ensuring large width dimensions in the attachment base portions 203A located in the vicinity of the fulcrums of resilient displacement of said attachment pieces 203 improves the springiness of the attachment pieces 203, thereby making it easy to ensure proper locked engagement between the locking engagement portions 203B and the lockingly engageable portions 54B.

As shown in FIGS. 11 and 12, the support pieces 204 are provided on the X2 side of the attachment pieces 203 in the connector width direction, or more specifically, in substantially the central range of the cover plate portion 201 in the connector width direction. In other words, in the present embodiment, the support pieces 204 are provided at locations different from the attachment pieces 203 in the connector width direction. The fact that the support pieces 204 and the attachment pieces 203 are positioned at different locations in the connector width direction makes it possible to fabricate the cap 200 from a single sheet metal member. In addition, the support pieces 204 are provided inwardly of the attachment pieces 203 in the terminal array direction. Therefore, as shown in FIG. 13(B), once the cap 200 is mounted to the plug connector 2, the support pieces 204 are accommodated within the receiving portion 55.

As shown in FIG. 13(B), the support pieces 204 have a support base portion 204A, which forms the top portion thereof, and a support portion 204B, which forms the bottom portion thereof, and are resiliently displaceable in the through-thickness direction (X-axis direction) with the section coupled to the cover plate portion 201, i.e., the top end portion of the support base portion 204A, serving as a fulcrum. As shown in FIG. 13(B), when the support pieces 204 are viewed in the connector width direction, the support base portion 204A extends at an outward incline in the terminal array direction (Y-axis direction) as it extends downward. In addition, the support portion 204B is bent so as to protrude outward in the terminal array direction.

In the present embodiment, the attachment pieces 203 and the support pieces 204, as a whole, are positioned at different locations in the connector width direction. As a variation, if the two respective base portions provided at the top end (on the mating side of the plug connector) in the attachment pieces and support pieces are coupled to the ends of the cover plate portion at locations different from each other in the connector width direction, at least parts of sections other than said base portions may overlap in the connector width direction. At such time, the overlapping sections will be positioned at different locations from one another in the up-down direction. For example, one piece among the attachment and support pieces may be made longer than the other piece and the bottom end portion of said one piece may be extended all the way to the range of the other piece in the connector width direction. At such time, said one piece, as a whole, will have a generally L-shaped configuration when viewed in the terminal array direction. Even if the attachment and support pieces are formed in this manner, the attachment and support pieces will not be at locations where they could interfere with one another in the sheet metal member before the cap is formed by bending, and therefore the cap can be formed from a single sheet metal member.

The cap 200 is mounted to the plug connector 2 in accordance with the following procedure. First, as shown in FIG. 11, the plug connector 2 is oriented such that the receiving portion 55 is upwardly open and the cap 200 is positioned above the plug connector 2. Next, the cap 200 is moved downwardly and attached to the plug connector 2. During the attachment process, the attachment pieces 203, with the locking engagement portions 203B thereof abutting the outer surface of the end walls 54 of the plug connector 2, are resiliently displaced outwardly in the terminal array direction. As shown in FIG. 13(C), when an attachment piece 203 reaches the standard attachment position, a portion of the locking engagement portion 203B enters the hole 56, and the attachment piece 203 is displaced inwardly in the terminal array direction so as to reduce the amount of resilient displacement. At such time, the attachment piece 203 is not in a free state but is in a slightly resiliently displaced state.

In the standard attachment position, the locking engagement portion 203B engages the lockingly engageable portion 54B from below. Since at such time the attachment piece 203 remains resiliently displaced, the locking engagement portion 203B is pressed against the outer surface of the end wall 54 under the resilient force thereof. As a result, the locked engagement between the locking engagement portion 203B and the lockingly engageable portion 54B is properly maintained and the cap 200 is unlikely to be inadvertently detached from the plug connector 2. In addition, in the standard attachment position, the support portion 204B supports the vertically intermediate area of the inner surface of the end walls 54 or, more specifically, a section located proximate to the bottom end of the end wall 54. Since at such time the support piece 204 remains resiliently displaced, the support portion 204B is pressed against the inner surface of the end wall 54 under the resilient force thereof. In other words, the end wall 54 is clamped by the attachment piece 203 and the support piece 204.

After being picked up by a suction device and placed on the mounting face of a circuit board, the plug connector 2, with the cap 200 mounted thereto, is heated in a reflow oven together with the circuit board and is mounted on the mounting face as a result of being solder connected thereto. During heating, the cap 200 remains mounted to the plug connector 2. Due to the fact that the plug connector 2 is shaped to extend such that the terminal array direction is the longitudinal direction, the plug housing 50 often undergoes warping deformation while shrinking in the terminal array direction. In the present embodiment, the support pieces 204 of the cap 200 support the inner surfaces of the end walls 54 of the plug housing 50 using the support portions 204B, thereby making it possible to properly minimize the warping deformation of the plug housing 50. In addition, in the present embodiment, the support portions 204B are adapted to support the vertically intermediate area of the inner surface of the end walls 54. Doing so makes it easy to minimize the warping deformation of the plug housing 50 during reflow soldering regardless of whether the warping deformation is concave warping deformation or convex warping deformation.

In addition, in the cap of the present embodiment, not only the support pieces 204, but also the attachment pieces 203 are provided along the surface of the end walls 54. Therefore, compared to when the attachment pieces of the cap are attached to the side walls of the plug housing, an increase in the size of the plug housing 50 in the terminal array direction can be avoided insofar as there is no need to provide sections for attaching said attachment pieces in the side walls.

The operation of mating of the socket connector 1 and the plug connector 2 will be described next. First, the socket connector 1 is mounted on the mounting face of a circuit board (not shown) through solder connections by reflow soldering and the plug connector 2 is mounted on the mounting face of another circuit board (not shown) through solder connections by reflow soldering. Next, as can be seen in FIGS. 1 and 2, the socket connector 1 is placed in an orientation in which the receiving portion 16 is facing upwardly, and the plug connector 2, oriented such that the receiving portion 55 is open downwardly, is placed above the socket connector 1. The process of mating with the socket connector 1 is then initiated by moving the plug connector 2 downwardly.

In the process of connector mating, the protruding wall 15 of the socket connector 1 enters the receiving portion 55 of the plug connector 2 from below. In addition, at the same time, the peripheral wall 52 of the plug connector 2 enters the receiving portion 16 of the socket connector 1 from above. As a result, the contact portions 63A of the outer plug terminals 60P abut the contact portions 23B of the outer socket terminals 20P and resiliently displace the arm portions 23 outwardly in the connector width direction. In addition, the contact portions 63A of the inner plug terminals 60Q abut the contact portions 23B of the inner socket terminals 20Q and resiliently displace the arm portions 23 inwardly in the connector width direction.

Furthermore, as can be seen in FIG. 3, as the process of connector mating advances and the plug connector 2 reaches the standard mating position, the socket connector 1 and the plug connector 2 enter a state of mated connection, and the connector mating operation is completed. In the state of mated connection of the connectors, the resiliently displaced state of the arm portions 23 of the socket terminals 20 is maintained, with the contact portions 23B making contact with the contact portions 63A under contact pressure. As a result, the socket terminals 20 and the plug terminals 60 are placed in electrical communication.

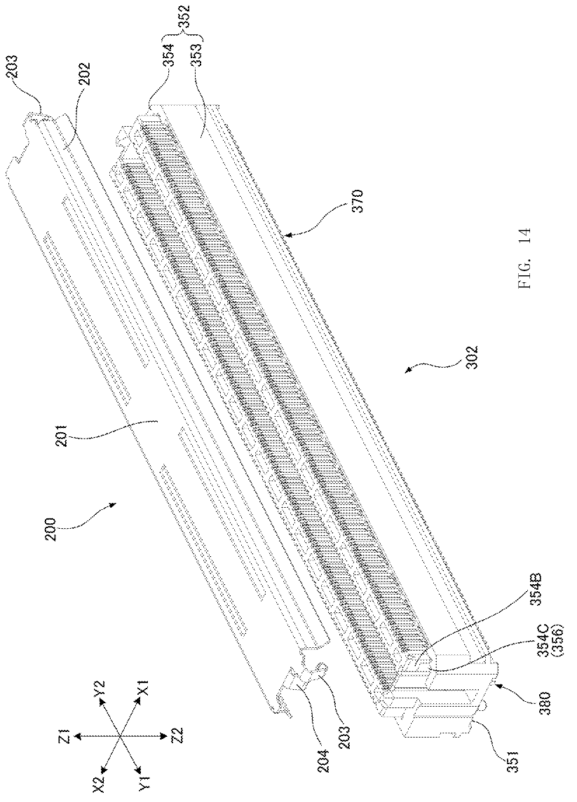

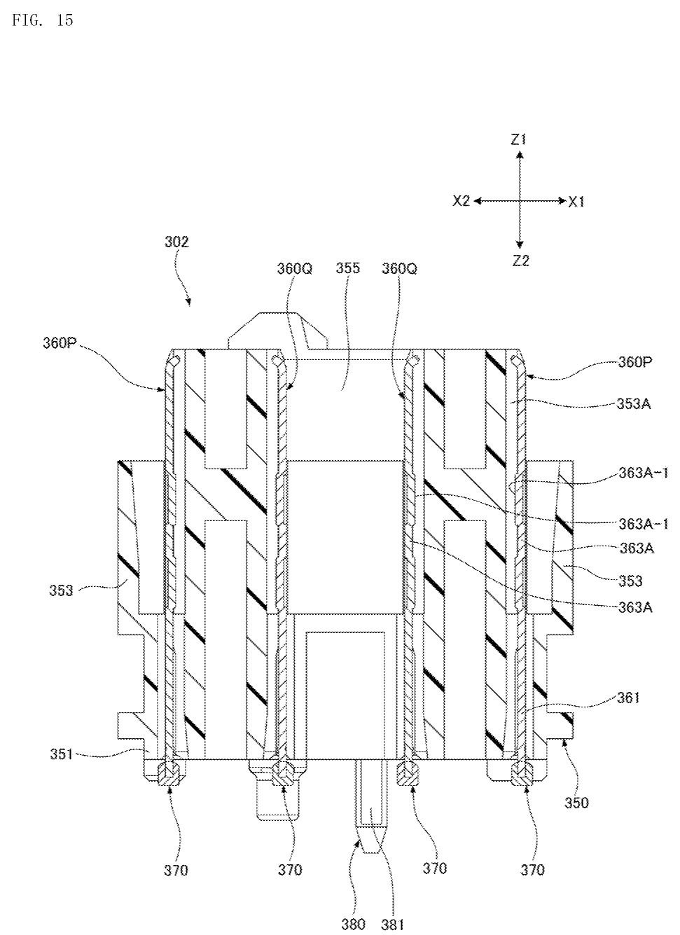

As a variation of the plug connector 2 of the present embodiment, the vertical dimensions (connector height dimensions) thereof may differ from those of the plug connector 2 in the previously discussed embodiment. As shown in FIGS. 14 and 15, the plug connector 302 is larger than the plug connector 2 of the previously discussed embodiment (see FIGS. 2 and 12) in the up-down direction. The configuration of the plug connector 302 according to this variation will be discussed with emphasis on sections different from those of the plug connector 2, and numerals obtained by adding “300” to the numerals used for said plug connector 2 will be assigned to the sections corresponding to the previously discussed plug connector 2. It should be noted that the plug connector 302 of FIG. 15 is shown in an orientation obtained by rotating 180 degrees about an axis in the Z-direction relative to the orientation of the plug connector 2 shown in FIG. 7.

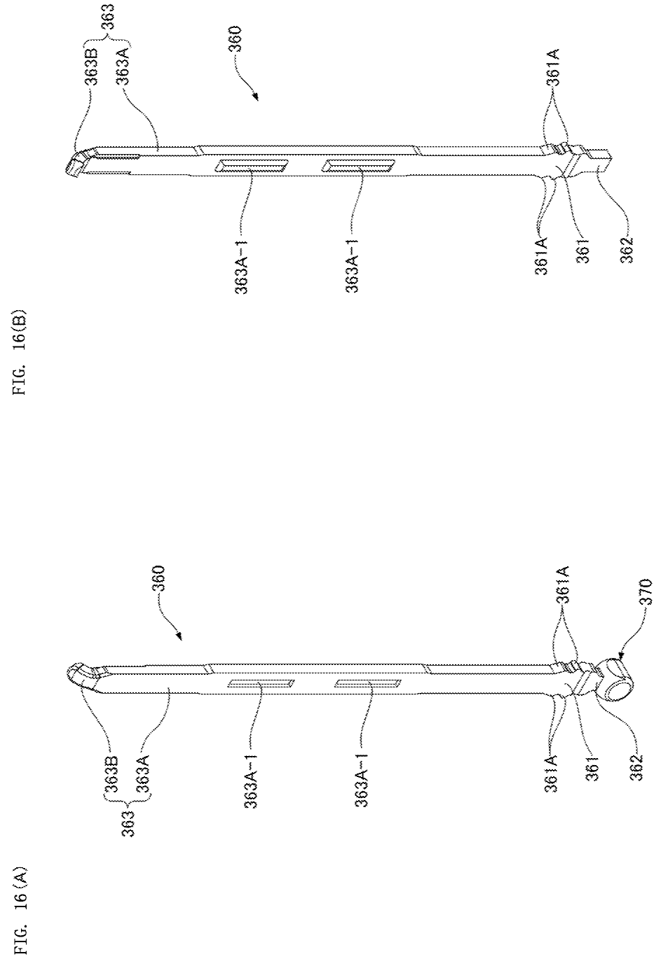

As shown in FIGS. 16(A) and 16(B), the shape of the plug terminals 360 provided in the plug connector 302 is obtained by making the contact portions 63A of the arm portions 63 of the plug terminals 60 of the previously discussed embodiment longer in the up-down direction. As shown in FIGS. 16(A) and 16(B), the dimensions (terminal width dimensions) of the arm portions 363 of the plug terminals 360 in the terminal width direction (Y-axis direction) are smaller than the maximum terminal width dimensions of the retained portions 361, i.e., the distance between the two apical portions of the press-fit portions 361A in the terminal width direction. Forming the arm portions 363 in this manner of smaller width dimensions than the maximum terminal width dimensions of the retained portions 361 makes it possible to introduce the plug terminals 360 into the plug housing 350 from the side of the bottom wall 51 and press-fit them using the retained portions 361. As shown in FIG. 16(B), a plurality of protrusions 363A-1 are provided side by side in the up-down direction in the vertically intermediate area of the contact portion 363A. The protrusions 363A-1, which are formed, for example, by embossing, extend in the up-down direction while protruding from the major face (the other major face) on the side opposite to the major face (the one major face) on which the contact surface is formed.

As shown in FIG. 16(B), the protrusions 363A-1 are located, in the direction facing the side walls 353 (X-axis direction), within the range of the gap between the protrusions 363A-1 and the side walls 353. Therefore, in this variation as well, in the same manner as in the previously discussed embodiment, by providing the protrusions 363A-1 using the above-mentioned gap, the dimension of the contact portions 363A in the through-thickness direction at the location of the protrusions 363A-1, as viewed in the terminal width direction (Y-axis direction), can be made sufficiently large, thereby suppressing an increase in impedance.

In addition, as shown in FIG. 14, the lockingly engageable portions 354B of the plug housing 350 are provided in the top portion of the end walls 354. Here, as can be seen by comparing FIGS. 14 and 7, the vertical distance from the top faces of the end walls 354 to the lockingly engageable portions 354B is the same as the vertical distance from the top faces of the end walls 54 to the lockingly engageable portions 54B in the previously discussed embodiment. Therefore, as shown in FIG. 14, the cap 200 of the previously discussed embodiment can be used “as is” in the plug connector 302.

### DESCRIPTION OF THE REFERENCE NUMERALS

1 Socket connector
2 Plug connector
10 Socket housing
11B Terminal retaining portion (retaining portion)
11B-1 Outer terminal retaining portion (retaining portion)
11B-2 Inner terminal retaining portion (retaining portion)
13 Side wall (wall portion)
15 Protruding wall (wall portion)
20 Socket terminal
21 Retained portion
21A Press-fit portion
23 Arm portion
23A-1 Protrusion
23C Inclined portion
30 Solder connection member
50 Plug housing
51B Terminal retaining portion (retaining portion)
51B-1 Outer terminal retaining portion (retaining portion)
51B-2 Inner terminal retaining portion (retaining portion)
53 Side wall (wall portion)
54 End wall
54C Notched portion
60 Plug terminal
60P Outer plug terminal
60Q Inner plug terminal
61 Retained portion
61A Press-fit portion
63 Arm portion
63B Inclined portion
70 Solder connection member
200 Cap
201 Cover plate portion
203 Attachment piece
203B Locking engagement portion
204 Support piece
360 Plug terminal
363A-1 Protrusion
L1 Ridge line
L2 Ridge line

1. An electrical connector for circuit boards mounted on a mounting face of a circuit board, said electrical connector for circuit boards comprising:
a plurality of terminals having a connection portion used for connecting to the mounting face formed at one end,
a housing that retains the plurality of terminals, and
solder connection members attached to the connection portions, wherein:
the solder connection members have at least one ridge line extending along the mounting face on the side facing the mounting face.

2. The electrical connector for circuit boards according to claim 1, wherein the connection portions are arranged side by side such that a direction parallel to the mounting face is the array direction, and
the solder connection members are attached to the connection portions in an orientation in which the ridge lines are perpendicular to the array direction.

3. The electrical connector for circuit boards according to claim 1, wherein the solder connection members have a round cylindrical shape, a polygonal cylindrical shape, a bale shape, or a barrel shape extending parallel to the mounting face.
